(19) United States
(12) Patent Application Publication
(10) Pub. No.: US 2014/0263053 A1
(43) Pub. Date: Sep. 18, 2014

(54) Filter System and Method

(71) Applicant: Taiwan Semiconductor Manufacturing Company, Ltd., (US)

(72) Inventors: Wen-Yun Wang, Taipei City (TW); Cheng-Han Wu, Taichung City (TW); Ching-Yu Chang, Yuansun Village (TW)

(73) Assignee: TAIWAN SEMICONDUCTOR MANUFACTURING COMPANY, LTD., Hsin-Chu (TW)

(21) Appl. No.: 13/797,045

(22) Filed: Mar. 12, 2013

(51) Int. Cl. B01D 65/06

(52) U.S. Cl. CPC B01D 65/06
USPC 210/636

(57) ABSTRACT

A system and method for treating a filter is provided. In an embodiment the filter is treated by pre-rinsing the filter membrane with a buffer solvent. The buffer solvent can be used to reduce or eliminate energy differences between the surface of the filter membrane and the process liquid which is being filtered. The pre-rinse may be performed prior to shipment or, alternatively, may be performed after shipment of the filter to a customer.

### BACKGROUND

In a semiconductor manufacturing process, semiconductor chips may be manufactured having devices such as transistors, resistors, capacitors, inductors, and the like formed therein. The manufacture of semiconductor chips may involve many processing steps, which may include combinations of photolithography, ion implantation, doping, annealing, packaging, etc. Many types of fluids may be used in these processes including water, dielectrics, polymers, photoresists, chemical etchants, acids, etc. These fluids are filtered and passed to manufacturing equipment, which uses the fluids during the manufacture of semiconductors.

### BRIEF DESCRIPTION OF THE DRAWINGS

For a more complete understanding of the present embodiments, and the advantages thereof, reference is now made to the following descriptions taken in conjunction with the accompanying drawings, in which:

FIGS. 1A-1C illustrate cross-sectional views of a filtering unit according to an embodiment;

FIG. 2 illustrates a pre-rinse of the filter in accordance with an embodiment;

FIG. 3 illustrates using the filter after the pre-rinse in accordance with an embodiment;

FIG. 4 illustrates a method of performing the pre-rinse prior to shipment in accordance with an embodiment; and

FIG. 5 illustrates a method of performing the pre-rinse after shipment in accordance with an embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The making and using of the embodiments of the present disclosure are discussed in detail below. It should be appreciated, however, that the present disclosure provides many applicable inventive concepts that can be embodied in a wide variety of specific contexts. The specific embodiments discussed are merely illustrative of specific ways to make and use the disclosed subject matter, and do not limit the scope of the different embodiments. Throughout the various views and illustrative embodiments, like reference numbers are used to designate like elements.

The embodiments will be described with respect to embodiments in a specific context, namely a filter and treatment for use in a semiconductor manufacturing process. The embodiments may also be applied, however, to other filters.

Referring now to FIG. 1A, there is shown a cross-sectional view of a filter 100 according to an embodiment of the present disclosure. In this embodiment the filter 100 may include a filter basin 101, a filter cap 103, and a filter membrane 111. The filter basin 101 may be any desired shape that may be suitable for contacting incoming process liquid 301 (e.g., water, liquid photoresists, spin-on compositions, or the like, as described below with respect to FIG. 3) with the filter membrane 111. In the embodiment illustrated in FIG. 1A, the filter basin 101 has a cylindrical sidewall and a bottom. However, the filter basin 101 is not limited to a cylindrical shape, and any other suitable shape, such as a hollow square tube, an octagonal shape, or the like, may alternatively be utilized. Furthermore, the filter basin 101 may be surrounded by a housing 105 made of material that is inert to the various process materials. As such, while the housing 105 may be any suitable material that can withstand the chemistries and pressures involved in the process, in an embodiment the housing 105 may be steel, stainless steel, nickel, aluminum, alloys of these, combinations of these, and like.

The filter basin 101 may also have a filter cap 103 to enclose the filter basin 101. The filter cap 103 may be attached to the housing 105 utilizing, e.g., a seal such as an o-ring, a gasket, or other sealant in order to prevent leakage from the filter basin 101 while at the same time allowing the filter cap 103 to be removed for access to the filter basin 101 within the interior of the housing 105. Alternatively, the filter cap 103 may be attached by welding, bonding, or adhering the filter cap 103 to the housing 105 in order to form an air-tight seal and prevent any leakage.

An inlet port 107 and an outlet port 109 may provide access to the filter basin 101 in order to receive the process liquid 301 and output a filtered process liquid 301, respectively. The inlet port 107 and the outlet port 109 may be formed in the filter cap 103 of the filter basin 101 (as illustrated in FIG. 1A) or may alternatively be formed through the sidewalls of the filter basin 101. In an embodiment the inlet port 107 and the outlet port 109 may also include various valves and fittings (not shown for clarity) to facilitate removal and replacement of the filter basin 101.

The filter cap 103 may also include a vent port 116. The vent port 116 may be used to controllably vent process gases that may arise either during maintenance of the filter 100 or else during emergency conditions in order to controllably relieve pressure that may build up in the filter 100. The vent port 116 may also include various valves and fittings (not shown for clarity) in order to facilitate installation or operation of the vent port 116.

The filter membrane 111 may be used to filter the process liquid 301 that passes into the filter basin 101 through the inlet port 107, through the filter membrane 111, and out of the filter basin 101 through the outlet port 109. In an embodiment the filter membrane 111 is located between the inlet port 107 and the outlet port 109 so that the process liquid 301 has to pass through the filter membrane 111 prior to leaving the filter basin 101.

FIG. 1B illustrates with a perspective view and in greater detail (although still not to scale) a portion of the filter membrane 111 surrounded by the dashed box 113 in FIG. 1A. As can be seen, the filter membrane 111 comprises a filter material 119 with a series of pores 115 that allow the process liquid 301 to flow through the filter membrane 111 (represented in FIG. 1B with the directional arrows labeled 117). The pores 115 act as the filtering mechanism and prevent particles and other impurities that have a larger size than the pores 115 from passing through the filter membrane 111. This removal of the impurities prevents the impurities from interfering with further processing once the process liquid 301 leaves the filter 100 for usage in the actual manufacturing of semiconductor devices.

As such, the size of the pores 115 is at least in part dependent upon the materials and processing into which the filter 100 will be placed. As particular examples, the size of the pores 115 is dependent at least is part on the size of the impurities that are desired to be removed while also taking into account other factors such as pressure drop that may be experienced through the filter 100, or the like. However, in an embodiment in which the process liquid 301 is a photoresist, the pores 115 may have a size of between about 1 nm and about 50 nm, such as about 10 nm.

The filter membrane 111 may be made of a filter material 119 that is chemically inert to the process liquid 301 being filtered so that the process liquid 301 being filtered is not significantly altered chemically as it passes through the filter membrane 111. In an embodiment the filter material 119 may comprise a nonpolar polymer such as polyethylene (UPE), which has a surface energy that ranges between 31 dynes/cm and 85 dynes/cm, whose repeating chemical structure is illustrated below:

[chemical structure]

By using a nonpolar polymer such as UPE, the ability of the filter material 119 to remove a particular size of impurities may be physically controlled by the size of the pores 115.

However, because UPE is nonpolar, UPE is also hydrophobic, which can cause problems when the filter 100 is utilized to filter a hydrophilic process liquid 301 such as water or an aqueous solution. In particular, the surface properties mismatch (e.g., hydrophobic membrane vs. hydrophilic material to be filtered) will result in a repulsive force occurring between the surface of the filter material 119 and the process liquid 301. This repulsive force can prevent the process liquid 301 from wetting the surface of the filter material 119 and also present a removal of gases from the surface of the filter material 119.

Because of this surface property mismatch causing the repulsive force resulting in the continued presence of gasses, it becomes much more difficult to pass the process liquid 301 through the filter membrane 111. While a high pressure (e.g., 50 MPa) may be used to overcome these issues to force the process liquid 301 through the filter membrane, such a solution has many down sides associated with it. For example, such high pressures may force polymer aggregate from the filter membrane 111 to break off into the process liquid 301, may cause some undesired impurities to penetrate through the filter membrane 111, or may even cause the housing 105 to break, causing a potential safety issue.

In alternative embodiments, the filter material 119 for the filter membrane 111 may comprise a different material with a different property. For example, the filter material 119 may comprise a polar polymer which, because of its polarity, is hydrophylic. In a particular embodiment the filter material 119 may be a material such as nylon, who has a surface energy of about 47 dynes/cm, and whose repeating chemical structure is illustrated below:

[chemical structure]

By using a material such as nylon, the surface mismatch between the filter material 119 and, e.g., an aqueous process liquid 301, may be reduced, and nylon can even be used to attract and chemically absorb polar impurities. However, while using a polar, hydrophylic material such as nylon to filter aqueous solutions may reduce the surface property mismatch between the filter material 119 and the process liquid 301, materials such as nylon are not suitable for filtering aqueous solutions that have a pH of less than about 7 because of a risk of hydrolysis. As such, while nylon is fully included in the embodiments as a material that can be used for the filter material 119, the use of nylon by itself does not provide all of the benefits of the current embodiments.

Additionally, the filter material 119 is not limited to being simply those materials (e.g., UPE and nylon) as described above. For example, other filtering materials, such as polytetrafluoroethylene (PTFE, which as surface energy of about 18 dynes/cm), Teflon, a Teflon-coating material, or the like, may alternatively be utilized. Any suitable material may be used, and all such materials are fully intended to be included within the scope of the embodiments.

FIG. 1C illustrates one particular pore 115 within the filter membrane 111, with FIG. 1C illustrating (again not to scale) an embodiment in which UPE is utilized for the filter material 119. As illustrated, the UPE makes up the outer surface of the filter material 119 which will come into contact with the process liquid 301 as the process liquid 301 passes through the filter membrane 111 (the passing is represented by the line 123). However, given that the structure of UPE is nonpolar, the UPE and, therefore, the material of the filter membrane 111, will be hydrophobic and will repel a hydrophylic process liquid 301 from the surface of the filter material 119. Given this, gas 125 that is present adjacent to the filter membrane 111 will not be removed from the surface of the filter membrane 111 and a gas 125/filter membrane 111 interface will be maintained, making it harder to pass the process liquid 301 through the filter 100.

FIG. 2 illustrates a process that may be used to mitigate the problems that may arise through such a surface property mismatch between the filter membrane 111 and the process liquid 301. In an embodiment, the filter membrane 111 may be pre-rinsed by a buffer liquid 201 prior to using the filter 100 for filtering the process liquid 301. By using the buffer liquid 201, the interface between the filter membrane 111 and surrounding gases 125 (e.g., air) is interrupted and bubbles adjacent to the filter membrane 111 are removed, thereby lowering the surface energy difference between the filter membrane 111 and subsequently filtered process liquid 301.

In an embodiment the buffer liquid 201 may be a water-based, aqueous solution, comprising one or more buffer materials. Alternatively, the buffer liquid 201 may be a solvent-based solution, such as an organic solvent-based solution, or even a hybrid solution of water and solvent-based solutions, and may also comprise either acids or bases. However, any suitable solution may alternatively be utilized.

In an embodiment, at least one of the buffer materials within the buffer liquid 201 has a surface tension below the process liquid 301 which will be filtered. For example, if the process liquid 301 has a surface tension of 65 dynes/cm, then at least one of the buffer materials within the buffer liquid 201 may have a surface tension of less than about 65 dynes/sm. By utilizing a buffer material with a lower surface tension, then the buffer materials within the buffer liquid 201 will be able to interrupt the gas 125/filter material 119 interface better than the process liquid 301. By interrupting this interface and removing the gasses located along this interface, the buffer materials within the buffer liquid 201 will reduce the impact of the interface, allowing the process liquid 301 to be filtered with less resistance.

In a particular embodiment the at least one of the buffer materials within the buffer liquid 201 will also have a surface energy that is relatively similar to the filter material 119. For example, in an embodiment a gap between the surface energy of the at least one of the buffer materials and the filter material 119 may be less than about 40 dynes/cm.

In an embodiment the buffer materials may be a liquid with similar surface properties as the filter material 110. For example, in an embodiment in which the filter material 119 is hydrophobic (e.g., UPE), the buffer materials may be a hydrophobic solvent such as an alkane or alkene. Additionally, the alkane or alkene may comprise one or more functional groups such as an alcohol group, and aldehyde group, a ketone group, and ester group, an amine group, a carboxylic acid group, combinations of these, or the like. Particular embodiments for the buffer materials include N-Methyl-2-pyrrolidone (NMP, which has a surface tension of about 41 dynes/cm), propylene glycol methyl ether acetate (PGMEA, which has a surface tension of about 28 dynes/cm), cyclohexanone (CHN, which has a surface tension of about 35 dynes/cm), propylene glycol ethyl ether (PGEE, which has a surface tension of about 27.8 dynes/sm), gamma-butyrolactone (GBL, which has a surface tension of about 35.4 dynes/cm), isopropyl alcohol (IPA, which has a surface tension of about 21 dynes/cm), combinations of these, or the like, whose structures are respectively illustrated below.

[chemical structure]

The buffer materials may be used as a liquid by themselves. Alternatively, in an embodiment in which the buffer liquid 201 is a solution with an organic solvent or an aqueous solution, the buffer materials may have a concentration within the buffer liquid 201 of between about 0.01 wt % and about 40 wt %, such as about 1 wt %. However, any suitable concentration may alternatively be used.

Additionally, the buffer liquid 201 may comprise a surfactant. For example, the buffer liquid 201 may also include surfactants in order to help improve the ability of the buffer liquid 201 to coat the surface of the filter membrane 111. In an embodiment the surfactants may include nonionic surfactants, polymers having fluorinated aliphatic groups, surfactants that contain at least one fluorine atom and/or at least one silicon atom, polyoxyethylene alkyl ethers, polyoxyethylene alkyl aryl ethers, polyoxyethylene-polyoxypropylene block copolymers, sorbitan fatty acid esters, polyoxyethylene sorbitan fatty acid esters.

Specific examples of materials that may be used as surfactants include polyoxyethylene lauryl ether, polyoxyethylene stearyl ether, polyoxyethylene cetyl ether, polyoxyethylene oleyl ether, polyoxyethylene octyl phenol ether, polyoxyethylene nonyl phenol ether, sorbitan monolaurate, sorbitan monopalmitate, sorbitan monostearate, sorbitan monooleate, sorbitan trioleate, sorbitan tristearate, polyoxyethylene sorbitan monolaurate, polyoxyethylene sorbitan monopalmitate, polyoxyethylene sorbitan monostearate, polyoxyethylene sorbitan trioleate, polyoxyethylene sorbitan tristearate, polyethylene glycol distearate, polyethylene glycol dilaurate, polyethylene glycol dilaurate, polyethylene glycol, polypropylene glycol, polyoxyethylenestearyl ether and polyoxyethylene cetyl ether; fluorine containing cationic surfactants, fluorine containing nonionic surfactants, fluorine containing anionic surfactants, cationic surfactants and anionic surfactants, polyethylene glycol, polypropylene glycol, polyoxyethylene cetyl ether, combinations of these, or the like.

The buffer liquid 201 may also comprise an antibacterial agent in order to prevent bacterial growth and interference. In an embodiment the antibacterial agent may be a silver based agent such as a silver nitrate solution that is added to the buffer liquid 201 in order to prevent or mediate the formation of microbes or bacteria that could interfere with the filtering or processing. However, any suitable antibacterial agent may alternatively be utilized.

In a particular embodiment the buffer liquid 201 may comprise a process liquid 301 such as a photoresist. In an embodiment the photoresist includes a polymer resin along with one or more photoactive compounds (PACs) in a solvent. In an embodiment the polymer resin may comprise a hydrocarbon structure (such as an alicyclic hydrocarbon structure) that contains one or more groups that will decompose (e.g., acid labile groups) or otherwise react when mixed with acids, bases, or free radicals generated by the PACs (as further described below). In an embodiment the hydrocarbon structure comprises a repeating unit that forms a skeletal backbone of the polymer resin. This repeating unit may include acrylic esters, methacrylic esters, crotonic esters, vinyl esters, maleic diesters, fumaric diesters, itaconic diesters, (meth)acrylonitrile, (meth)acrylamides, styrenes, vinyl ethers, combinations of these, or the like.

Specific structures which may be utilized for the repeating unit of the hydrocarbon structure include methyl acrylate, ethyl acrylate, n-propyl acrylate, isopropyl acrylate, n-butyl acrylate, isobutyl acrylate, tert-butyl acrylate, n-hexyl acrylate, 2-ethylhexyl acrylate, acetoxyethyl acrylate, phenyl acrylate, 2-hydroxyethyl acrylate, 2-methoxyethyl acrylate, 2-ethoxyethyl acrylate, 2-(2-methoxyethoxy)ethyl acrylate, cyclohexyl acrylate, benzyl acrylate, 2-alkyl-2-adamantyl (meth)acrylate or dialkyl(1-adamantyl)methyl (meth)acrylate, methyl methacrylate, ethyl methacrylate, n-propyl methacrylate, isopropyl methacrylate, n-butyl methacrylate, isobutyl methacrylate, tert-butyl methacrylate, n-hexyl methacrylate, 2-ethylhexyl methacrylate, acetoxyethyl methacrylate, phenyl methacrylate, 2-hydroxyethyl methacrylate, 2-methoxyethyl methacrylate, 2-ethoxyethyl methacrylate, 2-(2-methoxyethoxy)ethyl methacrylate, cyclohexyl methacrylate, benzyl methacrylate, 3-chloro-2-hydroxypropyl methacrylate, 3-acetoxy-2-hydroxypropyl methacrylate, 3-chloroacetoxy-2-hydroxypropyl methacrylate, butyl crotonate, hexyl crotonate and the like. Examples of the vinyl esters include vinyl acetate, vinyl propionate, vinyl butylate, vinyl methoxyacetate, vinyl benzoate, dimethyl maleate, diethyl maleate, dibutyl maleate, dimethyl fumarate, diethyl fumarate, dibutyl fumarate, dimethyl itaconate, diethyl itaconate, dibutyl itaconate, acrylamide, methyl acrylamide, ethyl acrylamide, propyl acrylamide, n-butyl acrylamide, tert-butyl acrylamide, cyclohexyl acrylamide, 2-methoxyethyl acrylamide, dimethyl acrylamide, diethyl acrylamide, phenyl acrylamide, benzyl acrylamide, methacrylamide, methyl methacrylamide, ethyl methacrylamide, propyl methacrylamide, n-butyl methacrylamide, tert-butyl methacrylamide, cyclohexyl methacrylamide, 2-methoxyethyl methacrylamide, dimethyl methacrylamide, diethyl methacrylamide, phenyl methacrylamide, benzyl methacrylamide, methyl vinyl ether, butyl vinyl ether, hexyl vinyl ether, methoxyethyl vinyl ether, dimethylaminoethyl vinyl ether and the like. Examples of the styrenes include styrene, methyl styrene, dimethyl styrene, trimethyl styrene, ethyl styrene, isopropyl styrene, butyl styrene, methoxy styrene, butoxy styrene, acetoxy styrene, chloro styrene, dichloro styrene, bromo styrene, vinyl methyl benzoate, α-methyl styrene, maleimide, vinylpyridine, vinylpyrrolidone, vinylcarbazole, combinations of these, or the like.

In an embodiment the repeating unit of the hydrocarbon structure may also have either a monocyclic or a polycyclic hydrocarbon structure substituted into it, or else the monocyclic or polycyclic hydrocarbon structure may be the repeating unit, in order to form an alicyclic hydrocarbon structure. Specific examples of monocyclic structures that may be used include bicycloalkane, tricycloalkane, tetracycloalkane, cyclopentane, cyclohexane, or the like. Specific examples of polycyclic structures that may be used include adamantine, norbornane, isobornane, tricyclodecane, tetracycododecane, or the like.

The group which will decompose, otherwise known as a leaving group or, in an embodiment in which the PAC is a photoacid generator, and acid labile group, is attached to the hydrocarbon structure so that, it will react with the acids/bases/free radicals generated by the PACs during exposure. In an embodiment the group which will decompose may be a carboxylic acid group, a fluorinated alcohol group, a phenolic alcohol group, a sulfonic group, a sulfonamide group, a sulfonylimido group, an (alkylsulfonyl) (alkylcarbonyl)methylene group, an (alkylsulfonyl)(alkyl-carbonyl)imido group, a bis(alkylcarbonyl)methylene gourp, a bis(alkylcarbonyl)imido group, a bis(alkylsylfonyl)methylene group, a bis(alkylsulfonyl)imido group, a tris(alkylcarbonyl methylene group, a tris(alkylsulfonyl)methylene group, combinations of these, or the like. Specific groups that may be utilized for the fluorinated alcohol group include fluorinated hydroxyalkyl groups, such as a hexafluoroisopropanol group. Specific groups that may be utilized for the carboxylic acid group include acrylic acid groups, methacrylic acid groups, or the like.

In an embodiment the polymer resin may also comprise other groups attached to the hydrocarbon structure that help to improve a variety of properties of the polymerizable resin. For example, inclusion of a lactone group to the hydrocarbon structure assists to reduce the amount of line edge roughness after the photoresist has been developed, thereby helping to reduce the number of defects that occur during development. In an embodiment the lactone groups may include rings having five to seven members, although any suitable lactone structure may alternatively be used for the lactone group.

The polymer resin may also comprise groups that can assist in increasing the adhesiveness of the photoresist to underlying structures (e.g., the layer to be patterned 109). In an embodiment polar groups may be used to help increase the adhesiveness, and polar groups that may be used in this embodiment include hydroxyl groups, cyano groups, or the like, although any suitable polar group may alternatively be utilized.

Optionally, the polymer resin may further comprise one or more alicyclic hydrocarbon structures that do not also contain a group which will decompose. In an embodiment the hydrocarbon structure that does not contain a group which will decompose may includes structures such as 1-adamantyl(meth)acrylate, tricyclodecanyl (meth)acrylate, cyclohexayl (methacrylate), combinations of these, or the like.

Additionally, the photoresist also comprises one or more PACs. The PACs may be photoactive components such as photoacid generators, photobase generators, free-radical generators, or the like, and the PACs may be positive-acting or negative-acting. In an embodiment in which the PACs are a photoacid generator, the PACs may comprise halogenated triazines, onium salts, diazonium salts, aromatic diazonium salts, phosphonium salts, sulfonium salts, iodonium salts, imide sulfonate, oxime sulfonate, diazodisulfone, disulfone, o-nitrobenzylsulfonate, sulfonated esters, halogenerated sulfonyloxy dicarboximides, diazodisulfones, α-cyanooxyamine-sulfonates, imidesulfonates, ketodiazosulfones, sulfonyldiazoesters, 1,2-di(arylsulfonyl)hydrazines, nitrobenzyl esters, and the s-triazine derivatives, suitable combinations of these, and the like.

Specific examples of photoacid generators that may be used include α-(trifluoromethylsulfonyloxy)-bicyclo[2.2.1]hept-5-ene-2,3-dicarbo-ximide (MDT), N-hydroxy-naphthalimide (DDSN), benzoin tosylate, t-butylphenyl-α-(p-toluenesulfonyloxy)-acetate and t-butyl-α-(p-toluenesulfonyloxy)-acetate, triarylsulfonium and diaryliodonium hexafluoroantimonates, hexafluoroarsenates, trifluoromethanesulfonates, iodonium perfluorooctanesulfonate, N-camphorsulfonyloxynaphthalimide, N-pentafluorophenylsulfonyloxynaphthalimide, ionic iodonium sulfonates such as diaryl iodonium (alkyl or aryl) sulfonate and bis-(di-t-butylphenyl)iodonium camphanylsulfonate, perfluoroalkanesulfonates such as perfluoropentanesulfonate, perfluorooctanesulfonate, perfluoromethanesulfonate, aryl (e.g., phenyl or benzyl) triflates such as triphenylsulfonium triflate or bis-(t-butylphenyl)iodonium triflate; pyrogallol derivatives (e.g., trimesylate of pyrogallol), trifluoromethanesulfonate esters of hydroxyimides, α,α′-bis-sulfonyl-diazomethanes, sulfonate esters of nitro-substituted benzyl alcohols, naphthoquinone-4-diazides, alkyl disulfones, and the like.

In an embodiment in which the PACs are a free-radical generator, the PACs may comprise n-phenylglycine, aromatic ketones such as benzophenone, N,N-tetramethyl-4,4′-diaminobenzophenone, N,N′-tetraethyl-4,4′-diaminobenzophenone, 4-methoxy-4′-dimethylaminobenzo-phenone, 3,3′-dimethyl-4-methoxybenzophenone, p,p′-bis(dimethylamino)benzo-phenone, p,p′-bis(diethylamino)-benzophenone, anthraquinone, 2-ethylanthraquinone, naphthaquinone and phenanthraquinone, benzoins such as benzoin, benzoinmethylether, benzomethylether, benzoinisopropylether, benzoin-n-butylether, benzoin-phenylether, methylbenzoin and ethybenzoin, benzyl derivatives such as dibenzyl, benzyldiphenyldisulfide and benzyldimethylketal, acridine derivatives such as 9-phenylacridine and 1,7-bis(9-acridinyl)heptane, thioxanthones such as 2-chlorothioxanthone, 2-methylthioxanthone, 2,4-diethylthioxanthone, 2,4-dimethylthioxanthone and 2-isopropylthioxanthone, acetophenones such as 1,1-dichloroacetophenone, p-t-butyldichloro-acetophenone, 2,2-diethoxyacetophenone, 2,2-dimethoxy-2-phenylacetophenone, and 2,2-dichloro-4-phenoxyacetophenone, 2,4,5-triarylimidazole dimers such as 2-(o-chlorophenyl)-4,5-diphenylimidazole dimer, 2-(o-chlorophenyl)-4,5-di-(m-methoxyphenyl imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer and 2-(p-methylmercaptophenyl)-4,5-diphenylimidazole dimmer, suitable combinations of these, or the like.

In an embodiment in which the PACs are a photobase generator, the PACs may comprise quaternary ammonium dithiocarbamates, a aminoketones, oxime-urethane containing molecules such as dibenzophenoneoxime hexamethylene diurethan, ammonium tetraorganylborate salts, and N-(2-nitrobenzyloxycarbonyl)cyclic amines, suitable combinations of these, or the like. However, as one of ordinary skill in the art will recognize, the chemical compounds listed herein are merely intended as illustrated examples of the PACs and are not intended to limit the embodiments to only those PACs specifically described. Rather, any suitable PAC may alternatively be utilized, and all such PACs are fully intended to be included within the scope of the present embodiments.

Another additive that may be added to the photoresist is a quencher, which may be utilized to inhibit diffusion of the generated acids/bases/free radicals within the photoresist, which helps the resist pattern configuration as well as to improve the stability of the photoresist over time. In an embodiment the quencher is an amine such as a second lower aliphatic amine, a tertiary lower aliphatic amine, or the like. Specific examples of amines that may be used include trimethylamine, diethylamine, triethylamine, di-n-propylamine, tri-n-propylamine, tripentylamine, diethanolamine, and triethanolamine, alkanolamine, combinations of these, or the like.

Alternatively, an organic acid may be utilized as the quencher. Specific embodiments of organic acids that may be utilized include malonic acid, citric acid, malic acid, succinic acid, benzoic acid, salicylic acid, phosphorous oxo acid and its derivatives such as phosphoric acid and derivatives thereof such as its esters, such as phosphoric acid, phosphoric acid di-n-butyl ester and phosphoric acid diphenyl ester; phosphonic acid and derivatives thereof such as its ester, such as phosphonic acid, phosphonic acid dimethyl ester, phosphonic acid di-n-butyl ester, phenylphosphonic acid, phosphonic acid diphenyl ester, and phosphonic acid dibenzyl ester; and phosphinic acid and derivatives thereof such as its esters, including phosphinic acid and phenylphosphinic acid.

In an embodiment the buffer liquid 201 may be contacted to the filter material 119 prior to using the filter 100 to filter the process liquid 301 in a number of ways. In a first embodiment the buffer liquid 201 may be pumped, poured, injected, or otherwise inserted into the filter basin 101, where it will come into physical contact with the filter membrane 111 and the filter material 119. Once the filter membrane 111 has been wetted by the buffer liquid 201, the buffer liquid 201 may be left in contact with the filter membrane 111 until the filter 100 is ready to be used in order to prevent the filter membrane 111 from drying out and the gas 125/filter material 119 interface from reappearing. To minimize exterior interference, the inlet port 107 and the outlet port 109 may be sealed after filling the filter basin 101 with the buffer liquid 201.

In an embodiment this method of contacting may be performed at the manufacturing site where the filter 100 will be installed and used. For example, once the filter 100 has been received from a manufacturer, the customer who received the filter 100 may perform the pre-rinse prior to installation of the filter 100 by filling the filter basis 101 with the buffer liquid 201 and then sealing the buffer liquid 201 into the filter basis 101. The buffer liquid 201 may be left in the filter basin 101 (with the inlet port 107 and the outlet port 109 sealed), until the filter 100 is ready to be installed, such as during a maintenance turn-around or other suitable time for installation.

Alternatively, instead of a customer performing the pre-rinse by sealing the buffer liquid 201 into the filter basin 101, the manufacturer of the filter 100 may perform the pre-rinse. In this embodiment the manufacturer, after making, cleaning, and drying the filter 100, may perform the pre-rinse as described above, and leave the buffer liquid 201 in the filter 100 by sealing the inlet port 107 and the outlet port 109. Then, with the buffer liquid 201 still sealed within the filter 100, the manufacturer can ship the still wet filter 100 to the customer, where the customer can store the filter 100 along with the sealed buffer liquid 201 until the customer is ready to install the filter 100.

In yet another alternative embodiment, the buffer liquid 201 may be pumped through the filter 100 as part of a cleaning process either before or after the filter 100 has been installed. In such an embodiment, rather than sealing the buffer liquid 201 into the filter 100 until it is ready to be installed and used, the buffer liquid 201 is pumped into the filter 100 at a rate of between about 5 ml/min and about 1500 ml/min, for a time period of between about 5 min and about 15 hrs, such as about 2 hrs. In this way the buffer liquid 201 does not need to remain within the filter 100 itself, and the filter 100 does not need to be sealed.

If desired, multiple buffer liquids 201 may be utilized in a succession of pre-rinse steps. For example, a first buffer liquid 201 with a surface energy that is less than 40 dynes/cm from the surface energy of the filter material 119 (so that there is a surface energy gap of less than 40 dynes/cm) may be utilized to initially disrupt the gas 125/filter material 119 interface. Once this has been accomplished, a second buffer liquid 201 with surface energy properties that are closer to the process liquid 301 may be used to gradually bridge the difference between surface energies between the process liquid 301 and the filter material 119.

For example, in a particular embodiment in which the filter material 119 is a hydrophobic material, a hydrophobic solvent is initially utilized as the buffer liquid 201. Once the hydrophobic solvent has been used, a second buffer liquid 201 that is hydrophylic may be used. In a particular embodiment, this second buffer liquid 201 may be another one of the buffer liquids 201 discussed above or, alternatively, may be an initial amount of the process liquid 301 that will not be used for manufacturing but may be used to stabilize the filter 100 prior to using the filter 100 during manufacturing processes.

In yet another embodiment the succession of buffer liquids 201 may be incorporated into a cleaning process for the filter 100. In an embodiment the cleaning process may include various cleaning solutions, such as surfactant solutions, water rinses, and a succession of buffer liquids 201. In a particular embodiment there may be five steps to the cleaning process, including an initial rinse step, a cleaning solution step, a second rinse step to clear the cleaning solution, and the successive two buffer liquids 201. However, the precise sequence of these steps may modified as desired, and may be based on the cleaning efficiency of the solutions.

FIG. 3 illustrates the use of the filter 100 to filter the process liquid 301 prior to using the process liquid 301 in a manufacturing process. In an embodiment the process liquid 301 may be any suitable process liquid 301, such as a photoresist composition, a liquid etchant, a liquid layer (that will be cured into a solid), a rinse or cleaning composition (e.g., water or other cleaning solution), or any other suitable liquid that may be used in the manufacturing of semiconductor devices. In an embodiment in which the process liquid 301 is a photoresist, the process liquid 301 may be pumped through the filter 100 at a flow rate of between about 5 ml/min and about 1500 ml/min, such as about 1000 ml/min, with a pressure drop of less than about 1 MPa.

However, thanks to the pre-rinse of the filter membrane 111 prior to use of the filter 100 to filter the process liquid 301, bubbles that may form at the interface of the filter membrane 111 may be reduced or eliminated, thereby helping to overcome any surface property mismatch between the filter membrane 111 and the process liquid 301. As such, the process liquid 301 may be transported through the filter membrane 111 and filtered more easily than without the pre-rinse with the buffer liquid 201, thereby avoiding the necessity of higher pressures.

Additionally, by using a pre-rinse process, other attempts to avoid these issues may be avoided. In particular, one other attempt that has been used to overcome this surface property mismatch has been to modify the properties of the filter membrane 111 at the surface by coating the filter membrane 111 with, e.g., another polymer. This can lead to the newly coated polymer leaching into the filtered material, causing excessive materials to be wasted trying to stabilize the filter 100 prior to using the filter 100. By using the pre-rinse method, the properties of the filter membrane 100 do not need to be modified, thereby avoiding all of the issues involved with modifying the surface of the filter membrane 111.

FIG. 4 illustrates one embodiment of a method for performing the pre-rinse of the filter membrane 111 with the buffer liquid 201 prior to shipment to a customer. In this embodiment, the filter 100 is initially manufactured and assembled in a first pre-shipment process step 401. Once manufactured the completed filter 100 is cleaned in a second pre-shipment process step 403, and then dried in a third pre-shipment process step 405. Then, before the filter 100 is shipped to the end user (e.g., semiconductor manufacturing fabrication plant), the pre-rinse of the filter 100 as described above with respect to FIG. 2 may be performed in a fourth pre-shipment process step 407. Once the pre-rinse has been performed, the now wet filter 100 may be shipped to the customer site in a fifth pre-shipment process step 409, and installed by the customer for use in manufacturing processes in a sixth pre-shipment process step 411.

FIG. 5 illustrates another embodiment of a method for performing the pre-rinse of the filter membrane 111 with the buffer liquid 201 after shipment of the filter 100 to a customer. In this embodiment, the filter 100 is initially manufactured and assembled in a first post-shipment process step 501. Once manufactured the completed filter 100 is cleaned in a second post-shipment process step 503, and then dried in a third post-shipment process step 505. Then, while still dry, the filter 100 is shipped to the customer in a fourth post-shipment process step 505. Once received by the customer, the customer can perform the pre-rinse of the filter 100 in a fifth post-shipment process step 509, and the filter can be installed for use in a sixth post-shipment process step 511.

In accordance with an embodiment, a method of treating a filter comprising providing a filter, wherein the filter comprises a filter membrane and an input port, is provided. A first buffer solvent is introduced to the filter through the input port to contact the filter membrane, the first buffer solvent having a first surface tension less than a surface tension of a process liquid to be filtered.

In accordance with another embodiment, a method of treating a filter comprising inserting a first buffer liquid into an inlet port of a filter basin and contacting the first buffer liquid with a filter membrane within the filter basin, is provided. A process liquid is inserted into the filter, the process liquid having a first surface property mismatch with the filter membrane, wherein the first buffer liquid has a second surface property mismatch less than the first surface property mismatch.

In accordance with yet another embodiment, a filtering unit comprising a filter basin, a filter membrane within the filter basin, a filter cap attached to the filter basin, and a buffer liquid in the filter basin and in contact with the filter membrane, is provided. The buffer liquid has a surface energy less than a process liquid to be filtered with the filter.

Although the present embodiments and their advantages have been described in detail, it should be understood that various changes, substitutions and alterations can be made herein without departing from the spirit and scope of the disclosure as defined by the appended claims. For example, it will be readily understood by those skilled in the art that the structures and ordering of steps as described above may be varied while remaining within the scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of treating a filter, the method comprising:
providing a filter, wherein the filter comprises a filter membrane and an input port; and
introducing a first buffer solvent to the filter through the input port to contact the filter membrane, the first buffer solvent having a first surface tension less than a surface tension of a process liquid to be filtered.

2. The method of claim 1, wherein a surface energy gap between the first buffer solvent and the filter membrane is less than about 40 dyne/cm.

3. The method of claim 1, wherein the filter membrane comprises a hydrophobic material.

4. The method of claim 1, wherein the first buffer solvent displaces gas from a surface of the filter membrane.

5. The method of claim 1, further comprising sealing the filter after introducing the first buffer solvent.

6. The method of claim 1, wherein the first buffer solvent comprises a photoresist composition.

7. The method of claim 1, further comprising introducing a second buffer solvent different from the first buffer solvent after the introducing the first buffer solvent.

8. The method of claim 1, wherein the buffer solvent comprises N-Methyl-2-pyrrolidone (NMP), propylene glycol methyl ether acetate (PGMEA), cyclohexanone (CHN), propylene glycol ethyl ether (PGEE), gamma-butyrolactone (GBL), or isopropyl alcohol (IPA).

9. A method of treating a filter, the method comprising:
inserting a first buffer liquid into an inlet port of a filter basin;
contacting the first buffer liquid with a filter membrane within the filter basin; and
inserting a process liquid into the filter, the process liquid having a first surface property mismatch with the filter membrane, wherein the first buffer liquid has a second surface property mismatch less than the first surface property mismatch.

10. The method of claim 9, further comprising interrupting a gas interface with the filter membrane using the first buffer liquid.

11. The method of claim 10, wherein the first buffer liquid is a first photoresist composition and the process liquid is a second photoresist composition.

12. The method of claim 9, further comprising inserting a second buffer liquid into the filter basin after the inserting the first buffer liquid, the second buffer liquid having a third surface property mismatch with the filter membrane, wherein the third surface property mismatch is greater than the second surface property mismatch.

13. The method of claim 9, wherein the first buffer liquid comprises N-Methyl-2-pyrrolidone (NMP), propylene glycol methyl ether acetate (PGMEA), cyclohexanone (CHN), propylene glycol ethyl ether (PGEE), gamma-butyrolactone (GBL), or isopropyl alcohol (IPA).

14. A filtering unit comprising:
a filter basin;
a filter membrane within the filter basin;
a filter cap attached to the filter basin; and
a buffer liquid in the filter basin and in contact with the filter membrane, the buffer liquid having a surface energy less than a process liquid to be filtered with the filter.

15. The filter of claim 14, further comprising an input port, wherein the inlet port is sealed.

16. The filter of claim 14, wherein the buffer liquid is a photoresist.

17. The filter of claim 14, wherein the buffer liquid comprises a surfactant.

18. The filter of claim 14, wherein the buffer liquid comprises an antibacterial agent.

19. The filter of claim 14, wherein the buffer liquid comprises an alkane.

20. The filter of claim of 14, wherein the buffer liquid comprises a functional group, the functional group comprising an alcohol group, ether group, aldehyde group, ketone group, ester group, an amine group, or a carboxylic acid group.
